(19) United States
(12) Patent Application Publication
(10) Pub. No.: US 2003/0108369 A1
(43) Pub. Date: Jun. 12, 2003

(54) Sequential transfer assist blade assembly

(75) Inventors: Youti Kuo, Penfield, NY (US); Douglas A. McKeown, Geneseo, NY (US); David K. Ahl, Rochester, NY (US); Robert A. Gross, Penfield, NY (US)

Correspondence Address: Patent Documentation Center, Xerox Corporation, Xerox Square, 100 Clinton Ave. S. 20th Floor, Rochester, NY, 14644, US

(73) Assignee: Xerox Corporation

(21) Appl. No.: 10/003,243

(22) Filed: Dec. 6, 2001

(51) Int. Cl. G03G 15/20

(52) U.S. Cl. 399/310

(57) ABSTRACT

A sequential transfer-assist blade assembly includes (a) a first cam and blade assembly including a first blade segment having a first length (A1) and being movable for first contacting a first size image receiving sheet having a first center location and a first width (A2); (b) a second cam and blade assembly including a second blade segment and a third blade segment each having a second length (B1), and each being located adjacent a first end and a second end respectively of the first blade segment, the first, the second and the third blade segments being moveable for contacting a second size image receiving sheet such that the second and the third blade segments contact the second size image receiving sheet after the first blade segment, the second image receiving sheet having a center location coincident with the first center location, and having a second width (A2+2×B2); and (c) a third cam and blade assembly including a fourth blade segment and a fifth blade segment each having a third length (C1), and each being located adjacent the second blade segment and the third blade segment respectively, the first, the second, the third, the fourth and the fifth blade segments being moveable for contacting a third size image receiving sheet such that the fourth and the fifth blade segments contact the third size image receiving sheet after the second and the third blade segments, the third size image receiving sheet having a center location coincident with the first center location, and having a third width (A2+2×B2+2×C2).

### RELATED APPLICATIONS

This application is related to U.S. application Ser. No. ______ (Applicants' Docket No. D/A0511Q) entitled “Dual Cam Set Transfer Assist Blade System” filed on the same date herewith, and having at least one common inventor.

### BACKGROUND OF THE INVENTION

This invention relates generally to electrostatographic printers and copiers or reproduction machines, and more particularly, concerns a sequential segmented transfer assist blade assembly in which segments of the blade are engaged sequentially for contacting an image receiving sheet.

The process of transferring charged toner particles from an image bearing member (e.g. photoreceptor) to an image support substrate (e.g. copy sheet) is enabled by overcoming cohesive forces holding the toner particles to the image bearing member. The interface between the photoreceptor surface and image support substrate is not always optimal. Thus, problems may be caused in the transfer process when spaces or gaps exist between the developed image and the image support substrate. A critical aspect of the transfer process is focused on the application and maintenance of high intensity electrostatic fields in the transfer region for overcoming the cohesive forces acting on the toner particles as they rest on the photoreceptive member. Careful control of these electrostatic fields and other forces is required to induce the physical detachment and transfer-over of the charged toner particles without scattering or smearing of the developer material.

Alternatively, mechanical devices that force the image support substrate into intimate and substantially uniform contact with the image bearing surface have been incorporated into transfer systems. Various contact blade arrangements have been proposed for sweeping the backside of the image support substrate, with a constant force, at the entrance to the transfer region. However, deletions may occur using these methods, especially in duplex copying.

In some conventional transfer assist blade assemblies each segmented blade is actuated by a separate solenoid, so that such an assembly with four independent segmented blades requires four separate solenoids. In other conventional transfer assist blade assemblies as disclosed for example in U.S. Pat. No. 6,134,398, the engagement timing and the width adjustment of the segmented blades are under separate mechanical controls, and the blade width adjustment is separately controlled by a rack and pinion mechanism.

### SUMMARY OF INVENTION

In accordance with the present invention, there is provided a sequential transfer-assist blade assembly includes (a) a first cam and blade assembly including a first blade segment having a first length (A1) and being movable for first contacting a first size image receiving sheet having a first center location and a first width (A2); (b) a second cam and blade assembly including a second blade segment and a third blade segment each having a second length (B1), and each being located adjacent a first end and a second end respectively of the first blade segment, the first, the second and the third blade segments being moveable for contacting a second size image receiving sheet such that the second and the third blade segments contact the second size image receiving sheet after the first blade segment, the second image receiving sheet having a center location coincident with the first center location, and having a second width (A2+2×B2); and (c) a third cam and blade assembly including a fourth blade segment and a fifth blade segment each having a third length (C1), and each being located adjacent the second blade segment and the third blade segment respectively, the first, the second, the third, the fourth and the fifth blade segments being moveable for contacting a third size image receiving sheet such that the fourth and the fifth blade segments contact the third size image receiving sheet after the second and the third blade segments, the third size image receiving sheet having a center location coincident with the first center location, and having a third width (A2+2×B2+2×C2).

### BRIEF DESCRIPTION OF THE DRAWINGS

Other features of the present invention will become apparent as the following description proceeds and upon reference to the drawings, in which:

FIG. 1 is a schematic illustration of a electrostatographic reproduction machine incorporating the sequential transfer assist blade assembly of the present invention;

FIG. 2 is a schematic illustration of an enlarged portion of the machine of FIG. 1 showing the sequential transfer assist blade assembly of the present invention;

FIGS. 3a-3b is a perspective illustration of the multiple cam shaft assembly of the sequential transfer assist blade assembly of the present invention;

FIG. 4 is a perspective illustration of different sheet widths in relation to spacings of the multiple cams of the sequential transfer assist blade assembly of the present invention;

FIG. 5 is another perspective illustration of an alignment at home position of the multiple cams of FIG. 4;

FIG. 6 is a vertical side view of the sequential transfer assist blade assembly of the present invention with all blades at home position;

FIG. 7 is a vertical side view of the sequential transfer assist blade assembly of the present invention with blades A and Bf, Br engaged by corresponding cams;

FIG. 8 is a vertical side view of the sequential transfer assist blade assembly of the present invention with blades A, Bf, Br and Cf, Cr engaged by corresponding cams; and

FIG. 9 is a top view illustration of maximum difference of landing distances “LD” for each of the blades A, Bf, Br, Cf, Cr given the sequential engaging of the cams of the present invention.

### DETAILED DESCRIPTION OF THE INVENTION

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

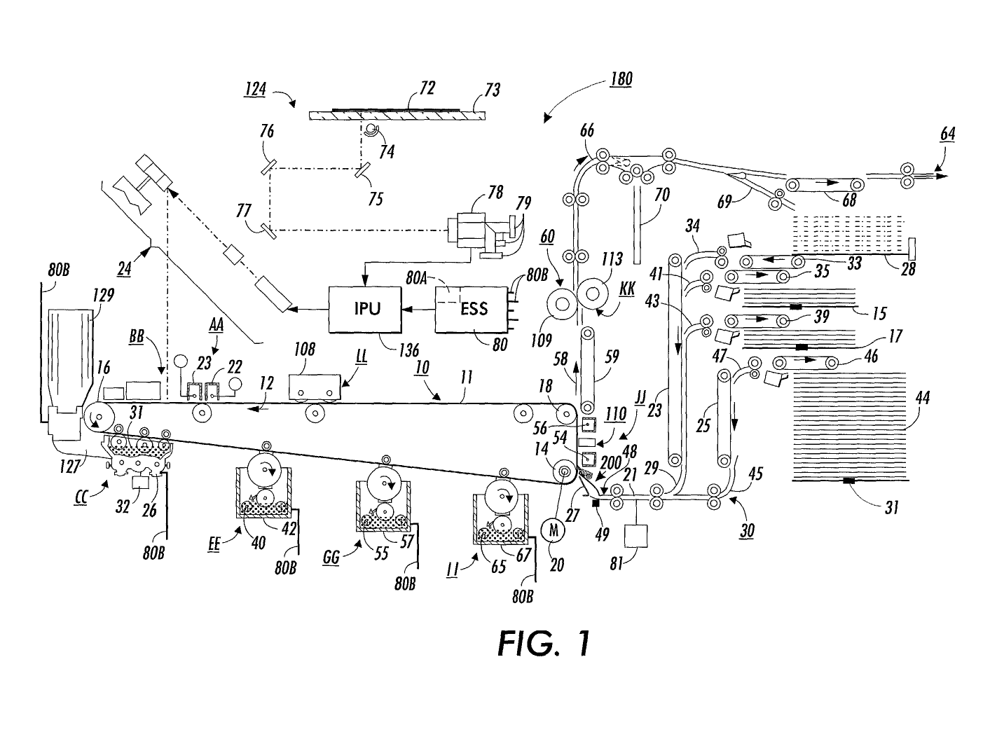

Referring first to FIG. 1, there is depicted an exemplary electrostatographic reproduction machine, for example, a multipass color electrostatographic reproduction machine 180. As is well known, the color copy process typically involves a computer generated color image which may be conveyed to an image processor 136, or alternatively a color document 72 which may be placed on the surface of a transparent platen 73. A scanning assembly 124, having a light source 74 illuminates the color document 72. The light reflected from document 72 is reflected by mirrors 75, 76, and 77, through lenses (not shown) and a dichroic prism 78 to three charged-coupled linear photosensing devices (CODs) 79 where the information is read. Each CCD 79 outputs a digital image signal the level of which is proportional to the intensity of the incident light. The digital signals represent each pixel and are indicative of blue, green, and red densities. They are conveyed to the IPU 136 where they are converted into color separations and bit maps, typically representing yellow, cyan, magenta, and black. IPU 136 stores the bit maps for further instructions from an electronic subsystem (ESS) 80 including the sequential transfer assist blade assembly 200 in accordance with the present invention (to be described in detail below).

The ESS is preferably a self-contained, dedicated mini-computer having a central processor unit (CPU), electronic storage, and a display or user interface (Ul). The ESS is the control system which with the help of sensors and connections 80B as well as a pixel counter 80A, reads, captures, prepares and manages the image data flow between IPU 136 and image input terminal 122, 124. In addition, the ESS 80 is the main multi-tasking processor for operating and controlling all of the other machine subsystems and printing operations. These printing operations include imaging, development, sheet delivery and transfer, and particularly the sequential transfer assist blade assembly 200 in accordance with the present invention. Such operations also include various functions associated with subsequent finishing processes. Some or all of these subsystems may have micro-controllers that communicate with the ESS 80.

The multipass color electrostatographic reproduction machine 180 employs a photoreceptor 10 in the form of a belt having a photoconductive surface layer 11 on an electroconductive substrate 13. Preferably the surface 11 is made from an organic photoconductive material, although numerous photoconductive surfaces and conductive substrates may be employed. The belt 10 is driven by means of motor 20 having an encoder attached thereto (not shown) to generate a machine timing clock. Photoreceptor 10 moves along a path defined by rollers 14, 18, and 16 in a counter-clockwise direction as shown by arrow 12.

Initially, in a first imaging pass, the photoreceptor 10 passes through charging station AA where a corona generating devices, indicated generally by the reference numeral 22, 23, on the first pass, charge photoreceptor 10 to a relatively high, substantially uniform potential. Next, in this first imaging pass, the charged portion of photoreceptor 10 is advanced through an imaging station BB. At imaging station BB, the uniformly charged belt 10 is exposed to the scanning device 24 forming a latent image by causing the photoreceptor to be discharged in accordance with one of the color separations and bit map outputs from the scanning device 24, for example black. The scanning device 24 is a laser Raster Output Scanner (ROS). The ROS creates the first color separatism image in a series of parallel scan lines having a certain resolution, generally referred to as lines per inch. Scanning device 24 may include a laser with rotating polygon mirror blocks and a suitable modulator, or in lieu thereof, a light emitting diode array (LED) write bar positioned adjacent the photoreceptor 10.

At a first development station CC, a non-interactive development unit, indicated generally by the reference numeral 26, advances developer material 31 containing carrier particles and charged toner particles at a desired and controlled concentration into contact with a donor roll, and the donor roll then advances charged toner particles into contact with the latent image and any latent target marks. Development unit 26 may have a plurality of magnetic brush and donor roller members, plus rotating augers or other means for mixing toner and developer.

A special feature of non-interactive development is that adding and admixing can continue even when development is disabled. Therefore the timing algorithm for the adding and admixing function can be independent of that for the development function, as long as admixing is enabled whenever development is required. These donor roller members transport negatively charged black toner particles for example, to the latent image for development thereof which tones the particular (first) color separation image areas and leaves other areas untoned. Power supply 32 electrically biases development unit 26. Development or application of the charged toner particles as above typically depletes the level and hence concentration of toner particles, at some rate, from developer material in the development unit 26. This is also true of the other development units (to be described below) of the machine 180.

Accordingly, different jobs of several documents being reproduced, will cause toner depletion at different rates depending on the sustained, copy sheet area toner coverage level of the images thereof being reproduced. In a machine using two component developer material as here, such depletion undesirably changes the concentration of such particles in the developer material. In order to maintain the concentration of toner particles within the developer material (in an attempt to insure the continued quality of subsequent images), the adding and admixing function of the development unit must be operating or turned “on” for some controlled period of time in order for the device 127 to replenish the development unit such as 26 with fresh toner particles from the source 129. Such fresh toner particles must then be admixed with the carrier particles in order to properly charge them triboeletrically.

On the second and subsequent passes of the multipass machine 180, the pair of corona devices 22 and 23 are employed for recharging and adjusting the voltage level of both the toned (from the previous imaging pass), and untoned areas on photoreceptor 10 to a substantially uniform level. A power supply is coupled to each of the electrodes of corona recharge devices 22 and 23. Recharging devices 22 and 23 substantially eliminate any voltage difference between toned areas and bare untoned areas, as well as to reduce the level of residual charge remaining on the previously toned areas, so that subsequent development of different color separation toner images is effected across a uniform development field.

Imaging device 24 is then used on the second and subsequent passes of the multipass machine 180, to superimpose subsequent a latent image of a particular color separation image, by selectively discharging the recharged photoreceptor 10. The operation of imaging device 24 is of course controlled by the controller, ESS 80. One skilled in the art will recognize that those areas developed or previously toned with black toner particles will not be subjected to sufficient light from the imaging device 24 as to discharge the photoreceptor region lying below such black toner particles. However, this is of no concern as there is little likelihood of a need to deposit other colors over the black regions or toned areas.

Thus on a second pass, imaging device 24 records a second electrostatic latent image on recharged photoreceptor 10. Of the four development units, only the second development unit 42, disposed at a second developer station EE, has its development function turned “on” (and the rest turned “off”) for developing or toning this second latent image. As shown, the second development unit 42 contains negatively charged developer material 40, for example, one including yellow toner. The toner 40 contained in the development unit 42 is thus transported by a donor roll to the second latent image recorded on the photoreceptor 10, thus forming additional toned areas of the particular color separation on the photoreceptor 10. A power supply (not shown) electrically biases the development unit 42 to develop this second latent image with the negatively charged yellow toner particles 40. As will be further appreciated by those skilled in the art, the yellow colorant is deposited immediately subsequent to the black so that further colors that are additive to yellow, and interact therewith to produce the available color gamut, can be exposed through the yellow toner layer.

On the third pass of the multipass machine 180, the pair of corona recharge devices 22 and 23 are again employed for recharging and readjusting the voltage level of both the toned and untoned areas on photoreceptor 10 to a substantially uniform level. A power supply is coupled to each of the electrodes of corona recharge devices 22 and 23. The recharging devices 22 and 23 substantially eliminate any voltage difference between toned areas and bare untoned areas, as well as to reduce the level of residual charge remaining on the previously toned areas so that subsequent development of different color toner images is effected across a uniform development field. A third latent image is then again recorded on photoreceptor 10 by imaging device 24. With the development functions of the other development units turned “off”, this image is developed in the same manner as above using a third color toner 55 contained in a development unit 57 disposed at a third developer station GG. An example of a suitable third color toner is magenta. Suitable electrical biasing of the development unit 57 is provided by a power supply, not shown.

On the fourth pass of the multipass machine 180, the pair of corona recharge devices 22 and 23 again recharge and adjust the voltage level of both the previously toned and yet untoned areas on photoreceptor 10 to a substantially uniform level. A power supply is coupled to each of the electrodes of corona recharge devices 22 and 23. The recharging devices 22 and 23 substantially eliminate any voltage difference between toned areas and bare untoned areas as well as to reduce the level of residual charge remaining on the previously toned areas. A fourth latent image is then again created using imaging device 24. The fourth latent image is formed on both bare areas and previously toned areas of photoreceptor 10 that are to be developed with the fourth color image. This image is developed in the same manner as above using, for example, a cyan color toner 65 contained in development unit 67 at a fourth developer station II. Suitable electrical biasing of the development unit 67 is provided by a power supply, not shown.

Following the black development unit 26, development units 42, 57, and 67 are preferably of the type known in the art which do not interact, or are only marginally interactive with previously developed images. For examples, a DC jumping development system, a powder cloud development system, or a sparse, non-contacting magnetic brush development system are each suitable for use in an image on image color development system as described herein. In order to condition the toner for effective transfer to a substrate, a negative pre-transfer corotron member 50 negatively charges all toner particles to the required negative polarity to ensure proper subsequent transfer.

Since the machine 180 is a multicolor, multipass machine as described above, only one of the plurality of development units, 26, 42, 57 and 67 may have its development function turned “on” and operating during any one of the required number of passes, for a particular color separation image development. The remaining development units must thus have their development functions turned off. As pointed out above and to be addressed below, the conventional approach is to use the same timing for the development function and the adding and admixing function, which causes design and operating conflicts in determining and effecting a control method for the “on” time for each development unit, particularly during sustained high area toner coverage jobs, in order to insure continued reproduction of high quality images without risking a quality or productivity degradation, or customer dissatisfaction.

Still referring to FIG. 1, during the exposure and development of the last color separation image, for example by the fourth development unit 6, 7 a sheet SS of support material is advanced to a transfer station JJ by a sheet feeding apparatus 30. During simplex operation (single sided copy), a blank sheet SS may be fed from tray 15 or tray 17, or a high capacity tray 44 thereunder, to a registration transport 21, in communication with controller 81, where the sheet is registered in the process and lateral directions, and for skew position. As shown, the tray 44 and each of the other sheet supply sources includes a sheet size sensor 31 that is connected to the controller 80. One skilled in the art will realize that trays 15, 17, and 44 each hold a different sheet type.

The speed of the sheet SS is adjusted at registration transport 21 so that the sheet arrives at transfer station JJ in synchronization with the composite multicolor image on the surface of photoconductive belt 10. Registration transport 21 receives a sheet from either a vertical transport 23 or a high capacity tray transport 25 and moves the received sheet to pretransfer baffles 27. The vertical transport 23 receives the sheet from either tray 15 or tray 17, or the single-sided copy from duplex tray 28, and guides it to the registration transport 21 via a turn baffle 29. Sheet feeders 35 and 39 respectively advance a copy sheet SS from trays 15 and 17 to the vertical transport 23 by chutes 41 and 43. The high capacity tray transport 25 receives the sheet from tray 44 and guides it to the registration transport 21 via a lower baffle 45. A sheet feeder 46 advances copy sheets SS from tray 44 to transport 25 by a chute 47.

As shown, pretransfer baffles 27 guide the sheet SS from the registration transport 21 to transfer station JJ. Charge limiter 49 located on pretransfer baffles 27 restricts the amount of electrostatic charge a sheet can place on the baffles 27 thereby reducing image quality problems and shock hazards. The charge can be placed on the baffles from either the movement of the sheet through the baffles or by the corona generating devices 54, 56 located at transfer station JJ. When the charge exceeds a threshold limit, charge limiter 49 discharges the excess to ground.

Transfer station JJ includes a transfer corona device 54 which provides positive ions to the backside of the copy sheet SS. This attracts the negatively charged toner powder images from photoreceptor belt 10 to the sheet SS. A detack corona device 56 is provided for facilitating stripping of the sheet SS from belt 10. A sheet-to-image registration detector 110 is located in the gap between the transfer and corona devices 54 and 56 to sense variations in actual sheet to image registration and provides signals indicative thereof to ESS 80 and controller 81 while the sheet SS is still tacked to photoreceptor belt 10.

The transfer station JJ also includes the sequential transfer assist blade assembly 200 of the present invention, (to be described in detail below) in which various segmented blades are engaged sequentially for contacting the backside of the image receiving sheet SS. After transfer, the sheet SS continues to move, in the direction of arrow 58, onto a conveyor 59 that advances the sheet to fusing station KK.

Fusing station KK includes a fuser assembly, indicated generally by the reference numeral 60, which permanently fixes the transferred color image to the copy sheet. Preferably, fuser assembly 60 comprises a heated fuser roller 109 and a backup or pressure roller 113. The copy sheet passes between fuser roller 109 and backup roller 113 with the toner powder image contacting fuser roller 109. In this manner, the multi-color toner powder image is permanently fixed to the sheet. After fusing, chute 66 guides the advancing sheet to feeder 68 for exit to a finishing module (not shown) via output 64. However, for duplex operation, the sheet is reversed in position at inverter 70 and transported to duplex tray 28 via chute 69. Duplex tray 28 temporarily collects the sheet whereby sheet feeder 33 then advances it to the vertical transport 23 via chute 34. The sheet fed from duplex tray 28 receives an image on the second side thereof, at transfer station JJ, in the same manner as the image was deposited on the first side thereof. The completed duplex copy exits to the finishing module (not shown) via output 64.

After the sheet of support material is separated from photoreceptor 10, the residual toner carried on the photoreceptor surface is removed therefrom. The toner is removed for example at cleaning station LL using a cleaning brush structure contained in a unit 108.

Referring now to FIGS. 1-9, the sequential transfer assist blade assembly 200 as variously illustrated includes a first cam and blade assembly 202 comprises a first blade segment A having a first length (A1) and being movable for first contacting a first size image receiving sheet SS1 having a first center location CL and a first width (A2). It also comprises a second cam and blade assembly 204 including a second blade segment Bf and a third blade segment Br each having a second length (B1), and each being located adjacent a first end and a second end respectively of the first blade segment A as shown.

The first, the second and the third blade segments A, Bf, Br as located are moveable for contacting a second size image receiving sheet SS2 such that the second and the third blade segments Bf, Br contact the second image receiving sheet after the first blade segment A has contacted such second size sheet. The second size image receiving sheet SS2 has a center location that is the same or coincident with the first center location, and a second width (A2+2×B2) where B2 relative to SS1, is the additional or incremental dimension of this third size sheet SS2 to each side of the center CL. The sequential transfer assist blade assembly 200 further comprises a third cam and blade assembly 206 including a fourth blade segment Cf and a fifth blade segment Cr each having a third length (C1), and each being located adjacent the second blade segment and the third blade segment respectively.

The first, the second, the third, the fourth and the fifth blade segments A, Bf, Br, Cf, Cr as located are moveable for contacting a third size image receiving sheet SS3 such that the fourth and the fifth blade segments Cf, Cr contact the third size image receiving sheet SS3 after the second and the third blade segments Bf, Br have contacted such third size sheet. The third size image receiving sheet SS3 has a center location that is also the same or coincident with the first center location CL, and has a third width (A2+2×B2+2×C2) where C2 relative to SS2, is the additional or incremental dimension of this third size sheet SS3 to each side of the center.

The first length (A1) of the first blade segment A is centered relative to the first center location CL of the first image receiving sheet, and is slightly less than the first width (A2) of the first image receiving sheet for preventing direct blade-to-image contact.

Similarly, the second length (B1) of each of the second and third blade segments Bf, Br is located and centered an equal distance from the first center location CL of the first image receiving sheet, and together with the first blade segment form a total blade length A1 +2×B1 that is slightly less than the second width (A2+2×B2) of the second image receiving sheet for preventing direct blade-to-image contact. The second blade segment and the third blade segment are supported on opposite ends of the first blade segment.

The third length (C1) of each of the fourth and the fifth blade segments Cf, Cr is also located and centered an equal distance from the first center location CL of the first image receiving sheet, and together with the first, the second, the third blade segments form a total blade length A1+2×B1+2×C1 that is slightly less than the third width (A2+2×B2+2×C2) of the third size image receiving sheet for preventing direct blade-to-image contact. The fourth blade segment Cf and the fifth blade segment Cr are supported oppositely from each other and adjacent the second blade segment Bf and the third blade segment Br respectively.

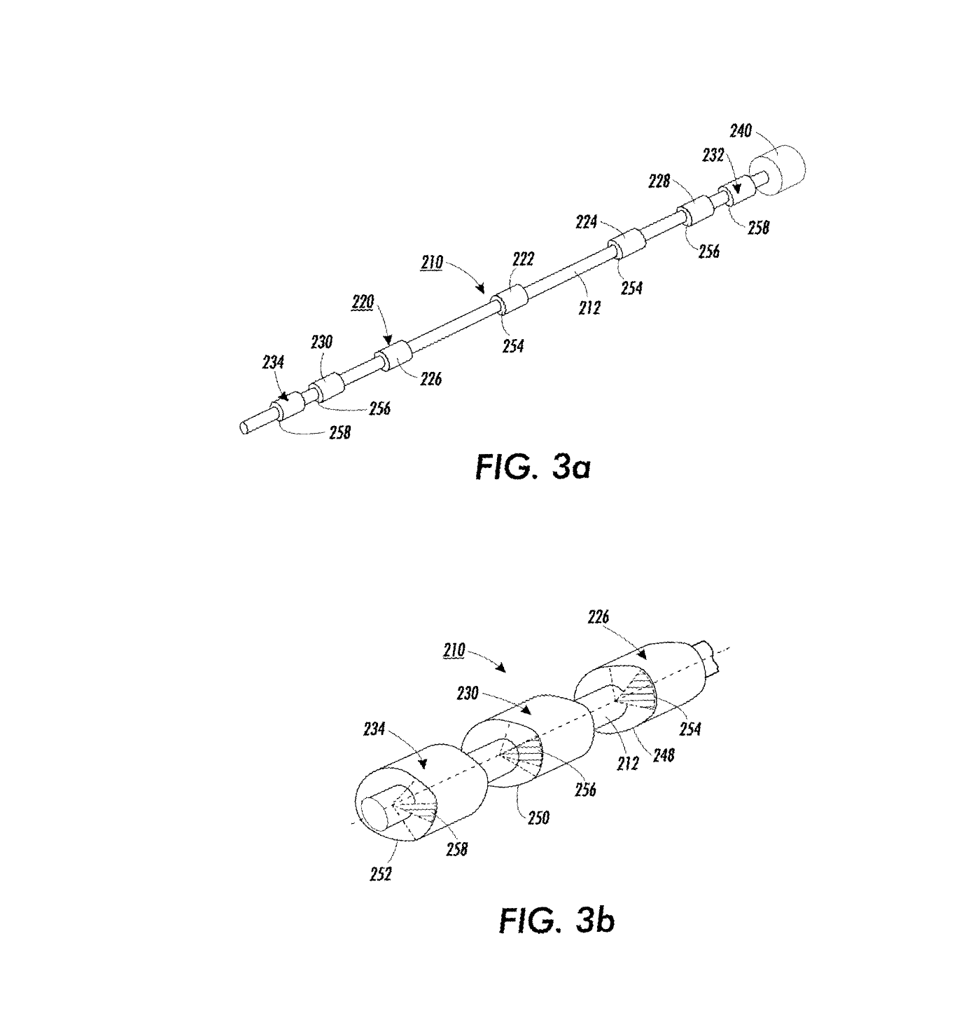

The sequential transfer assist blade assembly 200 also comprises a cam shaft assembly 210 including a rotatable cam shaft 212 and multiple cams 220 mounted thereon. As shown for example in FIGS. 3A-3B, the multiple cams 220 include at least one first cam 222, 224, 226 (three are actually included) corresponding to the first blade segment A and comprise part of the first cam and blade assembly 202. The multiple cams 220 also include second and third cams 228, 230 corresponding respectively to the second and third blade segments Bf, Br and comprising part of the second cam and blade assembly 204. The multiple cams 220 further include fourth and fifth cams 232, 234 corresponding to the fourth and fifth blade segments Cf, Cr and comprising a part of the third cam and blade assembly 206.

The cam shaft assembly 210 also includes a drive means in the form of a stepper motor 240 for rotatably moving the rotatable cam shaft 212. In accordance with an aspect of the present invention, the stepper motor 240 is reversible, or is bi-directional for first moving the cam shaft 212 in one direction to engage and contact their corresponding blades, and then in the opposite direction to disengage the cams from such blades.

The at least one first (three first cams 222, 224, 226 are actually shown), second 228 and third 230, as well as fourth 232 and fifth 234 cams, all have a common home position 242 that includes a home position 244. As shown, the at least one first 222, 224, 226, second 228, and third 230, as well as fourth 232 and fifth 234 cams are out of contact with all blade segments A, Bf, Br, Cf, Cr when at the home position 242.

The sequential transfer assist blade assembly 200 also comprises a controller 80 that is connected to the stepper motor 240 for controlling a degree of rotation of the rotatable cam shaft 212, and hence the sequential engagement of the cams thereon, and the blades A, Bf, Br, Cf, Cr.

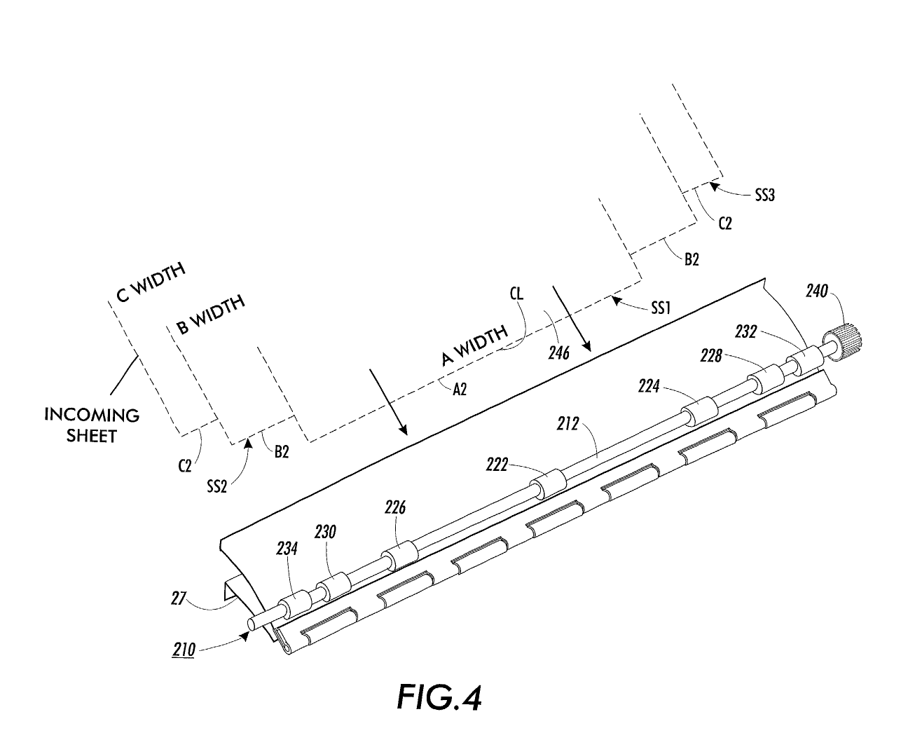

The controller 80 is also connected to a sheet width sensor 31 (FIG. 1) and is programmable to rotate the rotatable cam shaft 212 a predetermined number of motor steps for making blade-to-sheet contact based on a sensed width A2 or A2+2×B2 or A2+2×B2+2×C2, of the image receiving sheet. As shown in FIG. 4, the controller 80 is also programmable to rotate the rotatable cam shaft 212 a predetermined number of motor steps for contacting and landing each of the first, second and third, as well as fourth and fifth blade segments A, Bf, Br, Cf, Cr at a desired landing distance LD1, LD2, LD3 beyond a moving leading edge 246 of an image receiving sheet.

The at least one first 222, 224, 226, second 228, and third 230, as well as fourth 232 and fifth 234 cams, each have a cam profile or surface 248, 250 252 respectively including a single cam lobe 254, 256, 258 respectively. The single lobe 254, 256, 258 are each located to one side of a center of the cam surface 248, 250 252 for single direction rotational engagement with the blade segments A, Bf, Br, Cf, Cr. The second 228 and third 230 cams have identical profiles 256, and the fourth 232 and fifth 234 cams also have identical profiles 258. As shown, the first 222, 224, 226, second 228, and third 230, as well as fourth 232 and fifth 234 cams are arranged on the rotatable cam shaft 212 such that each single lobe 254, 256, 258 is controllable to make cam-to-blade contact in a desired sequence relative to the other cam profiles.

The sequential transfer-assist blade assembly 200, in addition to the cam shaft assembly 210, further comprises plural blade support levers including first 260, second 262, third 264, fourth 266 and fifth 268 blade support levers, each of which is pivotable.

In accordance with the present invention, the first blade segment A has a first length A1 that is sufficient for making full contact across a first size image receiving sheet SS1 having a first width A2. The second Bf and third Br blade segments each have a second length B1 that is equal to one-half of a difference between the first width A2 of the first size image receiving sheet SS1 and a second, and greater, width A2+2×B2 of a second size image receiving sheet SS2. Similarly, the fourth Cf and fifth Cr blade segments each have a third length C1 that is equal to one-half of a difference between the second, and greater, width A2+2×B2 of the second size image receiving sheet SS2 and a third width A2+2×B2+233 C2 of a third size image receiving sheet SS3, where the third width A2+2×B2+2×C2 is greater than the second width A2+2×B2.

The sequential transfer-assist blade assembly 200 is thus used in accordance with the present invention for contacting the back side of a sheet SS, of various widths, at the transfer station JJ (FIG. 1) so as to increase the toner image transfer efficiency, and to eliminate image deletions. The segmented blades A, Bf, Br, Cf, Cr thereof are thus adapted to match and correspond to the widths A2, A2+2×B2, and A2+2×B2+2×C2 of an incoming sheet. To prevent image deletions as above, it is desirable to eliminate any cockles and gaps between a sheet and the photoreceptor belt in a transfer zone, which may be a result of local sheet deformation and curl due to the fusing process. It is generally an objective of the sequential transfer assist blade assembly 200 to flatten a sheet in the transfer zone to achieve high transfer efficiency.

The multiple cams 220 include profiles or surfaces 248, 250, 252 having various ranges of constant radius. Turning the cam shaft 212 at various different angles can engage different sets of blades A, Bf, Br, Cf, Cr for various different sheet widths. The controls of print-to-print blade timing and adjustment of width are achieved through the use of the single cam shaft assembly 210, the bi-directional motor 240, and the controller 80.

In addition to applying contact pressure, each blade segment A, Bf, Br, Cf, Cr of the sequential transfer assist blade assembly 200 should only make contact with the back side of the image receiving sheet so as to avoid blade contact with the image or background toners on the photoreceptor outside the image area or beyond the width of the sheet. A blade segment whose width is wider than a sheet has a risk of not only abrading the photoreceptor but also contaminating the edge of the blade with background toners from areas outside of the width of the sheet. The blade in such a case will have to require cleaning, thus adding significant cost, as well as impacting the reliability of the transfer subsystem.

In accordance with the present invention, each of the segmented blades A, Bf, Br, Cf, Cr is such that the total length of any engaged combination of blade segments will be less than the width of the sheet being used, so that unengaged blade segments will not be in contact with background toners or the photoreceptor, in areas outside the width of such sheet.

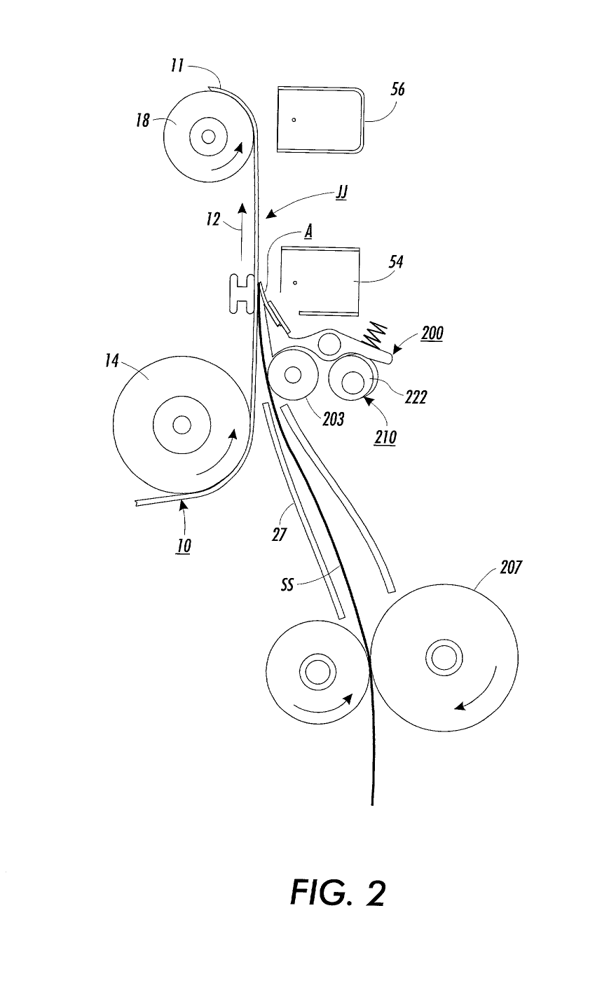

As shown in FIG. 2, the sequential transfer assist blade assembly 200 includes baffles 27, an idle roll 203, the cam shaft assembly 210, and the segmented blades A, Bf, Br, Cf, Cr. Also shown are (i) registration rolls 207 for providing input sheets SS to the transfer station JJ and (ii) corotron devices 54, 56 for applying electrostatic charge to sheets SS at the transfer station JJ.

The engagement of the segmented blades A, Bf, Br, Cf, Cr relies on control of a turning angle of the rotatable cam shaft 212. As shown, in FIGS. 3A-3B, different sets of cams 220 having different angular ranges of constant radius for dwell, are mounted on the cam shaft 212. The spacings of these cams and the timing sequence of cam lobes 254, 256, 258 in making contact with their corresponding blade segments are adapted for incrementally actuating segmented blades A, then Bf, Br, and then Cf, Cr in order to match the width A2, A2+2×B2, and A2+2×B2+2×C2 of the incoming sheet. FIGS. 3A-3B shows in perspective the rotatable cam shaft assembly 210, and the multiple cams 220 having the different profiles arranged for making sequential contact with the various sheets, at the desired landing distances LD1, LD2, LD3.

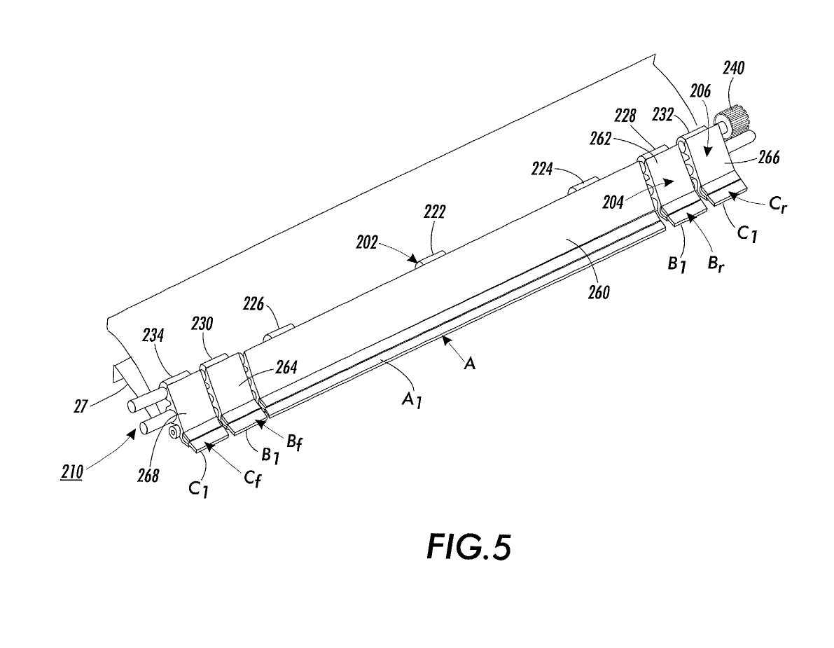

FIG. 4 shows the spacings between the cams on the rotatable cam shaft 212, and their correspondence with the various widths of incoming sheets SS1, SS2, SS3. FIG. 5 shows alignment of the cams against their corresponding blade segments A, Bf, Br, and Cf, Cr. For a center-registration system, for example, each of the first or middle three cams 222, 224, 226 (for the segment A blade) includes a significantly long cam lobe 254 having a constant radius for dwell, and together are arranged for engaging and contacting the middle blade (segment A blade) which is the narrowest of the three sheet widths. Each of the next two, or the second and third cams 228, 230 (for the segment Bf, Br blades) includes a reduced length cam lobe 256 that has a constant radius for dwell, and as shown, they are located on opposite sides of the first or middle cams 222, 224, 226. As such, they correspond to, and are suitable for engaging the two segment Bf, Br blades on either side of the central segment A blade. Together with the first or middle cams 222, 224, 226, these second and third cams 228, 230 are sufficient for engaging and contacting the middle blade (segment A blade) and the segment Bf, Br blades which correspond to the next size sheet width A2+2×B2. Similarly, the outer most or the fourth and fifth cams 232, 234 include the narrowest cam lobe 258 that has a constant radius for dwell, and are placed for engaging the outer most blades (Cf, Cr blades) for the widest sheet width A2+2×B2+2×C2.

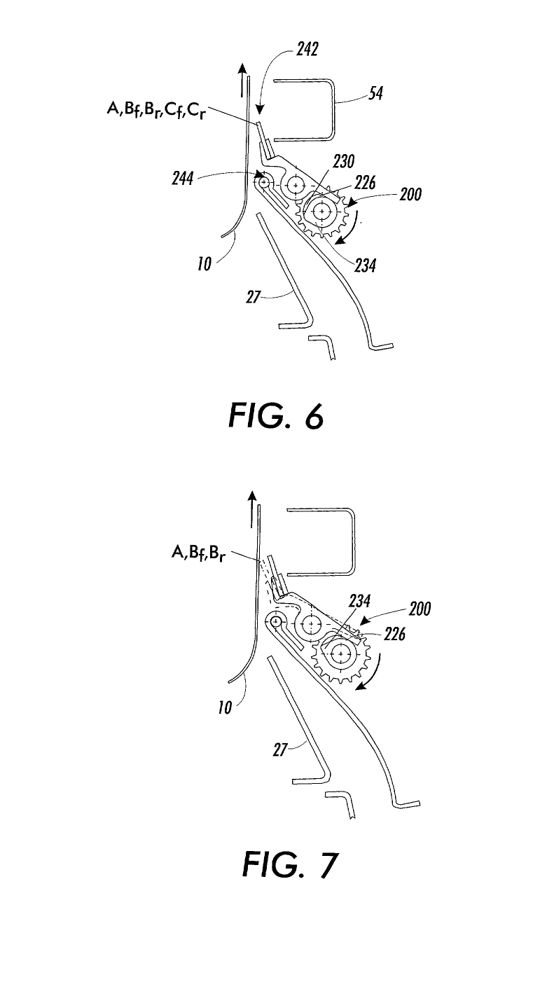

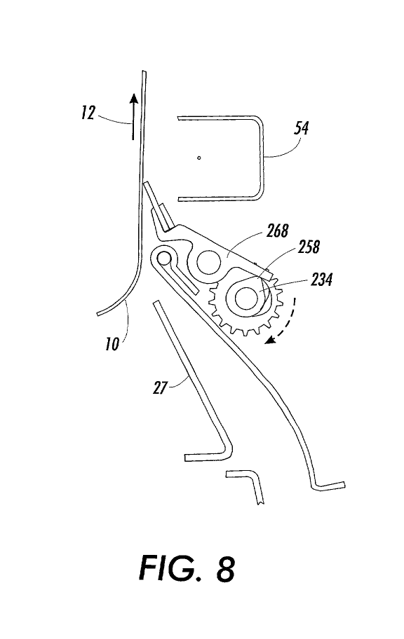

As pointed out above, all the cams are mounted on the cam shaft 212 so as to have a common home position 242 (FIG. 6), and such that, at the home position, all blades are fully lifted from the photoreceptor 10 and hence from the sheet SS as shown in FIG. 6. Furthermore, the cams are also arranged so that when each cam has been rotated to its maximum radius lobe point, its corresponding blade segment or segments will be fully lowered and in contact with the appropriate sheet, as shown in FIG. 7. In addition, the orientations of the cam lobes are aligned in such a way that, when the cam shaft 212 is activated to turn (counterclockwise) from the home position 242, the cams and their corresponding blade segments are sequentially engaged starting with the first or middle blade segment A, followed next by the blade segments Bf, Br, and then by the outer most blade segments Cf, Cr. As shown, for the first width A2 sheet, only the segment A blade is engaged. For the second width A2+2×B2 sheet, both the segment A and segment Bf, Br blades are engaged, and for third width A2+2×B2+2×C2 sheet, all blade segments are engaged. In other words, the sequential transfer assist blade assembly 200 can be programmed to control both the engagement timing and the width adjustment of the blades.

Control of the motion or rotation of the cam shaft 212 as pointed out above is accomplished through the use of the stepper motor 240 in conjunction with use of the home position sensor 244, and the controller 80. Accordingly, the number of steps of the stepper motor 240 that are required to turn the cam shaft for engagement of each set of blade segments can thus be programmed into a software control table. The table then can be used to effect the precise positioning of the desired combination of the cams for actuating corresponding blade segments based on a signal input about the width of an incoming sheet.

In operation, upon receiving the arrival time of the lead edge of such a sheet, the control software can activate the stepper motor 240 with a predetermined timing such that the middle A cams 222, 224, 226 are lowered from the home position 242 so as to land on the sheet SSS at a landing distance LD1 from the lead edge. It has been found that this landing distance depends on the speed of the stepper motor, the blade height, the turning angle of the cam shaft, as well as noise factors such as curl and speed variation of the sheet. After landing as such, the blades of course will stay in contact with the sheet SS for a predetermined duration depending on the length of the sheet, but the blades must be lifted from such sheet prior to the arrival of the trail edge of the sheet. Thus the stepper motor 240 can be a bi-directional stepper motor for also reversing rotation of the cam shaft 212 back to the home position 242.

Because of the sequential engagements of the cams as described above, the timings of engagement of the cam lobes with their corresponding blade segments, will vary from the first or middle cams to the second and third cams 228, 230, and then to the fourth and fifth or outer cams 232, 234. This timing variation is what creates or results in the differences in the landing distances LD1, LD2, LD3 of the different blade segments A, Bf, Br, Cf, Cr on the sheet being used. These differences in landing distances can of course be reduced if a higher speed stepper motor is used. In general, the maximum difference in landing distance between the first or middle blade, the segment A blade, and the outer blade segments or segment C92) blades can be estimated by the following equation:

Max. difference in landing distance=(Steps between mid & outer cams)×(Sheet speed)/(Motor step rate).

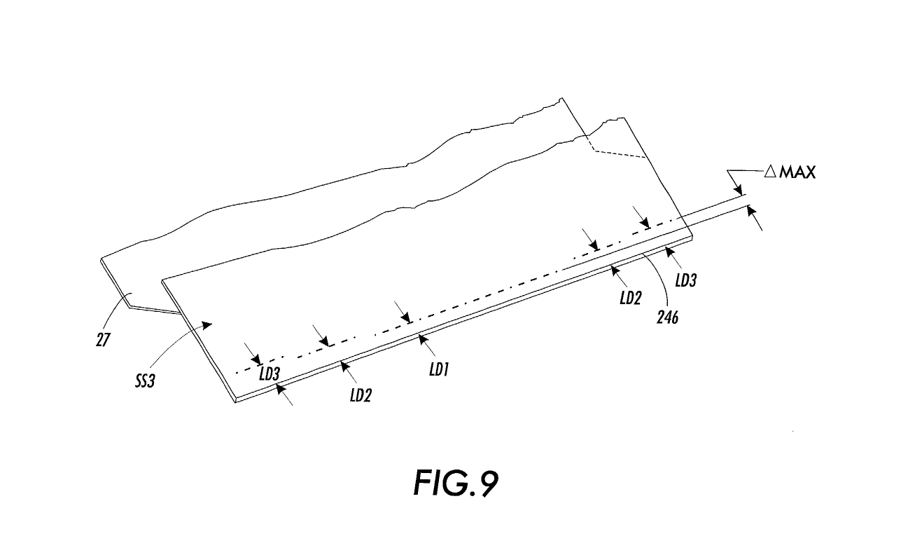

According to the above equation, the maximum difference in landing distance is 5 mm for a paper speed of 500 mm/sec, a stepper motor step rate of 2000 steps/sec, and for rotating an additional 20 steps to engage C cams 232, 234 after engaging the A cams 222, 224, 226. To engage B cams 228, 230 it will take 10 steps after engaging the A cams. Thus for a stepper motor having a step rate of 200 steps per revolution with a 1.8 degrees step angle, this will be equivalent to a motor speed of 600 RPM. Accordingly, the engaging angles of the cams as above can be designed to be 18 degrees apart. This difference of blade landing position and corresponding cam and blade positions are illustrated in FIG. 9.

Despite this variation in the landing distances from the middle blade segment A to the outer blade segment Cf, Cr, reasonable transfer efficiency near the outer lead edge 246 of the sheet can be enabled by providing a close proximity between the idle roll 203 and the photoreceptor belt 10. The idle roll 203 as such will act to force good contact between each sheet SS and the photoreceptor 10.

The sequential transfer assist blade assembly 200 of the present invention can be varied for example, as follows. In one variation, the idle roll 203 can be replaced by a spring-loaded rigid baffle or by an active drive roll for further reducing drag. In another, the segmented blades A, Bf, Br, Cf, Cr can instead be rigid but have spring loading for controlling the contact force. Still in a further embodiment, instead of a stepper motor 240, the stepping of the cam shaft 212 can be controlled by a retractable multi-stops clutch or by an electrical indexing clutch in conjunction with the use of a continuous running motor, a solenoid, and a gear chain for reversing the rotation of the cam shaft 212.

As can be seen, there has been provided a sequential transfer-assist blade assembly includes (a) a first cam and blade assembly including a first blade segment having a first length (A1) and being movable for first contacting a first size image receiving sheet having a first center location and a first width (A2); (b) a second cam and blade assembly including a second blade segment and a third blade segment each having a second length (B1), and each being located adjacent a first end and a second end respectively of the first blade segment, the first, the second and the third blade segments being moveable for contacting a second size image receiving sheet such that the second and the third blade segments contact the second size image receiving sheet after the first blade segment, the second image receiving sheet having a center location coincident with the first center location, and having a second width (A2+2×B2); and (c) a third cam and blade assembly including a fourth blade segment and a fifth blade segment each having a third length (C1), and each being located adjacent the second blade segment and the third blade segment respectively, the first, the second, the third, the fourth and the fifth blade segments being moveable for contacting a third size image receiving sheet such that the fourth and the fifth blade segments contact the third size image receiving sheet after the second and the third blade segments, the third size image receiving sheet having a center location coincident with the first center location, and having a third width (A2+2×B2+2×C2).

While the present invention will be described hereinafter in connection with a preferred embodiment thereof, it should be understood that it is not intended to limit the invention to that embodiment. On the contrary, it is intended to cover all alternatives, modifications and equivalents as may be included within the spirit and scope of the invention as defined in the appended claims.

What is claimed is:

1. A sequential transfer-assist blade (TAB) assembly for use at an image transfer station of an image reproduction machine to effectively contact image receiving sheets of various widths, the TAB assembly comprising:
a. a first cam and blade assembly including a first blade segment having a first length (A1) and being movable for first contacting a first size image receiving sheet having a first center location and a first width (A2);
b. a second cam and blade assembly including a second blade segment and a third blade segment each having a second length (B1), and each being located adjacent a first end and a second end respectively of said first blade segment, said first, said second and said third blade segments being moveable for contacting a second size image receiving sheet such that said second and said third blade segments contact the second size image receiving sheet after said first blade segment, said second size image receiving sheet having a center location coincident with said first center location, and having a second width (A2+2×B2); and
c. a third cam and blade assembly including a fourth blade segment and a fifth blade segment each having a third length (C1), and each being located adjacent said second blade segment and said third blade segment respectively, said first, said second, said third, said fourth and said fifth blade segments being moveable for contacting a third size image receiving sheet such that said fourth and said fifth blade segments contact the third size image receiving sheet after said second and said third blade segments, said third size image receiving sheet having a center location coincident with said first center location, and having a third width (A2+2×B2+2×C2).

2. The sequential transfer-assist blade assembly of claim 1, wherein said first length (A1) of said first blade segment is centered relative to said first center location of said first image receiving sheet, and is slightly less than said first width (A2) of said first image receiving sheet for preventing direct blade-to-image contact.

3. The sequential transfer-assist blade assembly of claim 1, wherein said second length (B1) of each of said second and third blade segments is located and centered an equal distance from said first center location of said first image receiving sheet, and together with said first blade segment form a total blade length A1+2×B1 that is slightly less than said second width (A2+2×B2) of the second image receiving sheet for preventing direct blade-to-image contact.

4. The sequential transfer-assist blade assembly of claim 1, wherein said third length (C1) of each of said fourth and said fifth blade segments is located and centered an equal distance from said first center location of said first image receiving sheet, and together with said first, said second, said third blade segments form a total blade length A1+2×B1+2×C1 that is slightly less than said third width (A2+2×B2+2×C2) of the third image receiving sheet for preventing direct blade-to-image contact.

5. The sequential transfer-assist blade assembly of claim 1, including a rotatable cam shaft and multiple cams mounted thereon, said multiple cams including at least one first cam corresponding to said first blade segment and comprising part of said first cam and blade assembly, second and third cams corresponding to said second and third blade segments and comprising part of said second cam and blade assembly; and fourth and fifth cams corresponding to said fourth and fifth blade segments and comprising a part of said third cam and blade assembly.

6. The sequential transfer-assist blade assembly of claim 5, including a stepper motor for rotatably moving said rotatable cam shaft.

7. The sequential transfer-assist blade assembly of claim 5, wherein said at least one first, second and third, as well as fourth and fifth cams, all have a common home position.

8. The sequential transfer-assist blade assembly of claim 5, including a controller connected to said stepper motor for controlling a degree of rotation of said rotatable cam shaft.

9. The sequential transfer-assist blade assembly of claim 5, wherein said at least one first, said second, said third, said fourth and said fifth cams, each have a cam profile, and are arranged on said cam shaft such that each said cam profile is controllable to make cam-to-blade contact in a desired sequence.

10. The sequential transfer-assist blade assembly of claim 6, wherein said stepper motor is reversible.

11. The sequential transfer-assist blade assembly of claim 7, including a home position sensor.

12. The sequential transfer-assist blade assembly of claim 7, wherein said at least one first, second and third, as well as fourth and fifth cams are out of contact with all blade segments when at said home position.

13. The sequential transfer-assist blade assembly of claim 8, wherein said controller is connected to a sheet width sensor and is programmed to rotate said rotatable cam shaft a predetermined number of motor steps for making blade-to-sheet contact based on a sensed width of the image receiving sheet.

14. The sequential transfer-assist blade assembly of claim 8, wherein said controller is programmed to rotate said rotatable cam shaft a predetermined number of motor steps for contacting and landing each of said first, second and third, as well as fourth and fifth blade segments at a desired landing distance beyond a moving leading edge of an image receiving sheet.

15. A sequential transfer-assist blade (TAB) assembly for contacting image receiving sheets having different sheet widths at an image transfer station in a reproduction machine, the sequential TAB assembly comprising:
a. plural blade support levers including first, second, third, fourth and fifth blade support levers, each said first, second, third, fourth and fifth support levers being pivotable;
b. a rotatable cam shaft assembly including a cam shaft, a drive means for rotating said cam shaft, and at least one first cam, a second cam, a third cam, a fourth cam and a fifth cam, mounted on said cam shaft and having first, second, third, fourth and fifth cam profiles arranged for making sequential contact with, and pivotably moving, said first, second, third, fourth and fifth blade support levers;
c. plural image transfer-assist blade segments including first, second, third, fourth and fifth segments, supported respectively on said first, second, third, fourth and fifth blade support levers, for contacting a backside of an image receiving sheet when moved into such contact by said first, second, third, fourth and fifth cam profiles and said first, second, third, fourth and fifth blade support levers; and
d. a controller connected to said drive means for controlling rotation of said rotatable cam shaft to effect movement of said cam profiles into a desired sequential contact with an image receiving sheet.

16. The sequential transfer-assist blade assembly of claim 15, wherein said first sequential transfer-assist blade segment has a first length sufficient for making full contact across a first size image receiving sheet having a first width.

17. The sequential transfer-assist blade assembly of claim 15, wherein said second and third blade segments each have a second length equal to one-half of a difference between said first width of the first size image receiving sheet and a second, and greater, width of a second size image receiving sheet.

18. The sequential transfer-assist blade assembly of claim 15, wherein said fourth and fifth blade segments each have a third length equal to one-half of a difference between said second, and greater, width of the second size image receiving sheet and a third width of a third size image receiving sheet, said third width being greater than said second width.

19. The sequential transfer-assist blade assembly of claim 15, wherein said drive means comprises a single stepper motor for driving said rotatable cam shaft.

20. An electrostatographic reproduction machine comprising:
(a) a moveable image bearing member having an imaging surface for carrying a toner image;
(b) a sheet supply and handling assembly for supplying and moving image receiving sheets of various widths into a toner image transfer relationship with said image bearing member;
(c) imaging devices for forming a toner image on said imaging surface for transfer to image receiving sheets; and
(i) a sequential transfer-assist blade (TAB) assembly for contacting the image receiving sheets of various widths, the TAB assembly including:
(ii) a first cam and blade assembly including a first blade segment having a first length (A1) and being movable for first contacting a first image receiving sheet having a first center location and a first width (A2);
(iii) a second cam and blade assembly including a second blade segment and a third blade segment each having a second length (B1), and each being located adjacent a first end and a second end respectively of said first blade segment, said first, said second, and said third blade segments being moveable for contacting a second image receiving sheet such that said second and said third blade segments contact the second image receiving sheet after said first blade segments, said second image receiving sheet having a center location coincident with said first center location, and having a second width (A2+2×B2); and
(iv) a third cam and blade assembly including a fourth blade segment and a fifth blade segment each having a third length (C1), and each being located adjacent said second blade segment and said third blade segment respectively, said first, said second, said third, said fourth and said fifth blade segments being moveable for contacting a third image receiving sheet such that said fourth and said fifth blade segments contact the third image receiving sheet after said second and said third blade segments, said third image receiving sheet having a center location coincident with said first center location, and having a third width (A2+2×B2+2×C2).
